(19) United States
(12) Patent Application Publication
(10) Pub. No.: US 2017/0372377 A1
(43) Pub. Date: Dec. 28, 2017

(54) PROVIDING IMAGE-LIKE VERSIONS OF TEXT ADVERTISEMENTS

(71) Applicant: Google Inc., Mountain View, CA (US)

(72) Inventors: Daniel Kaemmerer, San Francisco, CA (US); Adnan Virk, San Francisco, CA (US); Johan Land, Santa Clara, CA (US); Nathan P. Lucash, San Francisco, CA (US); Yuheng Kuang, Sunnyvale, CA (US); Omer Gimenez Llach, San Jose, CA (US); Radoslav M. Kirov, San Francisco, CA (US)

(21) Appl. No.: 14/318,528

(22) Filed: Jun. 27, 2014

(51) Int. Cl. G06Q 30/02

(52) U.S. Cl. CPC G06Q 30/0275

(57) ABSTRACT

Methods, systems, and apparatus include computer programs encoded on a computer-readable storage medium, including a method for providing content. A request is received for an advertisement for presentation in a slot. The request includes selection criteria. At least one selection criterion indicates a preference for display advertisements. Using the selection criteria, without regard for the preference, candidate advertisements are identified from an inventory that includes both display and other types of advertisements. An auction is conducted, including the identified candidates, determining a winning bid. A type of advertisement for the winning bid is determined. When the winning bid is associated with a display advertisement, a display advertisement is provided. When the winning bid is associated with a text advertisement, rendering parameters associated with the text advertisement are adjusted or added to enable display of an image-like version of the text advertisement, which is provided with the adjusted rendering parameters.

### BACKGROUND

This specification relates to information presentation.

The Internet provides access to a wide variety of resources. For example, video and/or audio files, as well as webpages for particular subjects or particular news articles, are accessible over the Internet. Access to these resources presents opportunities for other content (e.g., advertisements) to be provided with the resources. For example, a webpage can include slots in which content can be presented. These slots can be defined in the webpage or defined for presentation with a webpage, for example, along with search results. Content in these examples can be of various formats, while the devices that consume (e.g., present) the content can be equally varied in terms of their type and capabilities.

Slots can be allocated to content sponsors as part of a reservation system, or in an auction. For example, content sponsors can provide bids specifying amounts that the sponsors are respectively willing to pay for presentation of their content. In turn, an auction can be run, and the slots can be allocated to sponsors according, among other things, to their bids and/or a likelihood that the user will interact with the content presented.

### SUMMARY

In general, one innovative aspect of the subject matter described in this specification can be implemented in methods that include a computer-implemented method for providing content. The method includes receiving a request for an advertisement for presentation in a slot associated with a resource, wherein the request includes one or more selection criteria, and wherein at least one selection criterion indicates a preference for display advertisements. The method further includes identifying candidate advertisements from an inventory using the one or more selection criteria without regard for the preference, wherein the inventory includes both display advertisements and other types of advertisements including text advertisements. The method further includes conducting an auction including the identified candidates, wherein conducting includes determining a winning bid. The method further includes determining a type of advertisement associated with the winning bid. When the winning bid is associated with a display advertisement, providing the display advertisement responsive to the request. When the winning bid is associated with a text advertisement, adjusting or adding rendering parameters associated with the text advertisement so as to enable display of an image-like version of the text advertisement and providing the text advertisement with the adjusted rendering parameters for display responsive to the received request.

These and other implementations can each optionally include one or more of the following features. The rendering parameters can include a background shading. The background shading can be configured to darken on hover. The rendering parameters can include a selection of typeface, and adjusting can include selecting a typeface that is different than a typeface originally associated with the text advertisement. The rendering parameters can include spacing, and adjusting can include expanding spacing between elements of the text advertisement including adjusting spacing for one or more of the title, uniform resource locator, or body text. The method can further include adding an item to the text advertisement, wherein the item is selected from the group comprising a control, an arrow, a chevron, or favicon. The control can be a call-to-action control. The rendering parameters can include a positioning parameter, and adjusting can include adjusting positioning of elements of the textual advertisement to fill the slot. The rendering parameters can include a background color, and adjusting can include setting the background color to a new single color. The rendering parameters can include a spacing parameter, and adjusting can include tightening spacing, as compared to an original spacing, in a title of the text advertisement.

In general, another innovative aspect of the subject matter described in this specification can be implemented in computer program products that include a computer program product tangibly embodied in a computer-readable storage device and comprising instructions. The instructions, when executed by one or more processors, cause the processor to: receive a request for an advertisement for presentation in a slot associated with a resource, wherein the request includes one or more selection criteria, and wherein at least one selection criterion indicates a preference for display advertisements; identify candidate advertisements from an inventory using the one or more selection criteria without regard for the preference, wherein the inventory includes both display advertisements and other types of advertisements including text advertisements; conduct an auction including the identified candidates, wherein conducting includes determining a winning bid; and determine a type of advertisement associated with the winning bid including: when the winning bid is associated with a display advertisement, provide the display advertisement responsive to the request; and when the winning bid is associated with a text advertisement, adjust or add rendering parameters associated with the text advertisement so as to enable display of an image-like version of the text advertisement, and provide the text advertisement with the adjusted rendering parameters for display responsive to the received request.

These and other implementations can each optionally include one or more of the following features. The rendering parameters can include a background shading. The background shading can be configured to darken on hover. The rendering parameters can include a selection of typeface, and adjusting can include selecting a typeface that is different than a typeface originally associated with the text advertisement. The rendering parameters can include spacing, and adjusting can include expanding spacing between elements of the text advertisement including adjusting spacing for one or more of the title, uniform resource locator, or body text.

In general, another innovative aspect of the subject matter described in this specification can be implemented in systems, including a system comprising one or more processors and one or more memory elements including instructions. The instructions, when executed, cause the one or more processors to: receive a request for an advertisement for presentation in a slot associated with a resource, wherein the request includes one or more selection criteria, and wherein at least one selection criterion indicates a preference for display advertisements; identify candidate advertisements from an inventory using the one or more selection criteria without regard for the preference, wherein the inventory includes both display advertisements and other types of advertisements including text advertisements; conduct an auction including the identified candidates, wherein conducting includes determining a winning bid; and determine a type of advertisement associated with the winning bid including: when the winning bid is associated with a display advertisement, provide the display advertisement responsive to the request; and when the winning bid is associated with a text advertisement, adjust or add rendering parameters associated with the text advertisement so as to enable display of an image-like version of the text advertisement, and provide the text advertisement with the adjusted rendering parameters for display responsive to the received request

These and other implementations can each optionally include one or more of the following features. The rendering parameters can include a background shading. The background shading can be configured to darken on hover. The rendering parameters can include a selection of typeface, and adjusting can include selecting a typeface that is different than a typeface originally associated with the text advertisement. The rendering parameters can include spacing, and adjusting can include expanding spacing between elements of the text advertisement including adjusting spacing for one or more of the title, uniform resource locator, or body text.

Particular implementations may realize none, one or more of the following advantages. Image-like versions of text ads can be generated in response to requests for content from resources associated with publishers that have specified “display-only” as a preference. For example, image-like versions of text ads can be automatically generated and provided, e.g., for publishers who prefer not to show text ads because of their visual appearance, or for other reasons. Publishers may receive additional revenue when more content items in inventory are eligible for presentation (hence increasing competition in the selection process). Content sponsors (e.g., advertisers) can opt into using, for their creatives, specially-designed formats that automatically render display-like versions of their text ads without additional efforts by the advertiser.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content.

FIG. 2 shows an example system for providing an image-like version of a text ad.

FIG. 3 is a flowchart of an example process for providing an image-like version of a text ad.

FIG. 4 is a block diagram of an example computer system that can be used to implement the methods, systems and processes described in this disclosure.

Like reference numbers and designations in the various drawings indicate like elements.

### DETAILED DESCRIPTION

Systems, methods, and computer program products are described for providing an image-like version of a text only content item (e.g., advertisement). For example, a request for an advertisement (or “ad”) for presentation in a slot associated with a resource can be received, such as to fill the slot on a resource associated with a publisher. The publisher may have a preference for display-type ads to be used on the resource, such preference being known to the serving system or being included in the received request. For example, the request can include one or more selection criteria, including, for example, at least one selection criterion that indicates a preference for display ads. Candidate ads that satisfy the request can be identified from an inventory of eligible content items. Identification of the candidate ads can use the one or more selection criteria without regard for the preference (for display ads). The identification can be made from the inventory that includes both display ads and other types of ads, including text ads. A selection process can be used (e.g., an auction can be conducted) that includes the identified candidates, and one or more winners of the selection process can be identified. A type of content item associated with the one or more winners can be determined. When a winner is associated with a display ad, for example, the display ad can be provided (e.g., as-is) responsive to the request. When the winner is associated with a text ad, for example, rendering parameters associated with the text ad can be adjusted or added so as to enable display of an image-like version of the text ad. The text ad can be provided with the adjusted rendering parameters for display responsive to the received request. Example adjusted rendering parameters include a background shading parameter (e.g., including configuring the background shading to darken on hover), a typeface parameter (e.g., using a typeface that is different than a typeface originally associated with the text ad), an expansion parameter (e.g., for expanding spacing between elements of the text ad), a control parameter (e.g., for adding an arrow, a chevron, or favicon, and/or including a call-to-action control), a positioning parameter (e.g., to adjust positioning of elements of the textual ad to fill the slot), and/or a spacing parameter (e.g., to tighten spacing of characters or words in the ad).

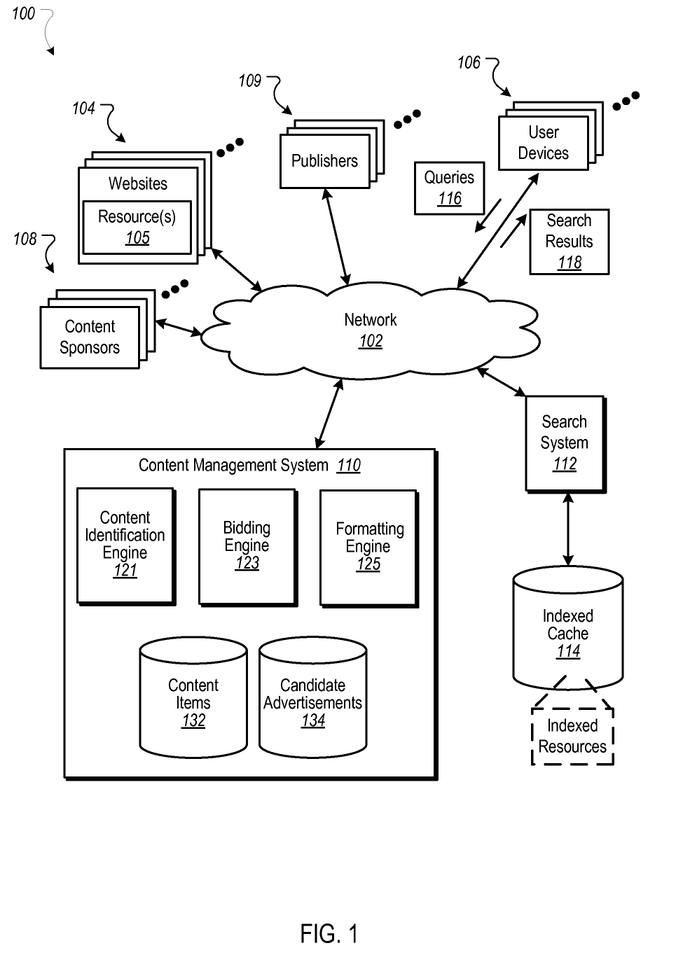

FIG. 1 is a block diagram of an example environment 100 for providing content. The example environment 100 includes a content management system 110 for selecting and providing content in response to requests for content. The example environment 100 includes a network 102, such as a local area network (LAN), a wide area network (WAN), the Internet, or a combination thereof. The network 102 connects websites 104, user devices 106, content sponsors 108 (e.g., advertisers), publishers 109, and the content management system 110. The example environment 100 may include many thousands of websites 104, user devices 106, content sponsors 108 and publishers 109.

The environment 100 can include plural data stores, which can be stored locally by the content management system 110, stored somewhere else and accessible using the network 102, generated as needed from various data sources, or some combination of these. Further, some data stores described herein may include identifiers that can be used to match or access corresponding data records or other information that are stored elsewhere, e.g. locally and/or remotely.

An inventory of content items 132, for example, can include content items (e.g., advertisements) that can be selected from in response to a received request for content (e.g., an ad request). The inventory of content items 132 can include, for example, an inventory of content items (e.g., creatives) provided by content sponsors 108 for presentation to users.

A data store of candidate advertisements 134, for example, can include eligible content items that have been identified as being responsive to a particular request for content. For example, the candidate advertisements 134 associated with a given request for content can include content items that match keywords for the request and/or other signals (e.g., user information, location, slot size and other parameters).

A content identification engine 121, for example, can identify candidate content items from the inventory of content items 132 that are responsive to a received request for content. For example, the content identification engine 121 can identify candidate advertisements 134 from inventory, the identification performed, at least in part, by matching keywords or other information in the request for content.

A bidding engine 123, for example, can conduct a selection process (e.g., an auction), including using bids associated with content items (e.g., advertisements), to determine a winning bid associated with a winning content item. For example, a winning bid in an auction can be determined based on one or more factors, such as quality scores derived from content performance, landing page scores, the likelihood of user interaction with the content item, and/or other factors.

A formatting engine 125, for example, can determine a type of a content item (e.g., an advertisement) associated with the winning bid (e.g., display, text, etc.). The formatting engine 125 can also adjust and/or add rendering parameters to text-type content items. For example, the formatting engine 125 can create an image-like version of a text ad. The image-like version can be provided in response to an ad request (e.g., resulting in selection of the text ad) to enable display of the image-like version in lieu of the normal text ad presentation. Adding and adjusting are discussed in greater detail below

A website 104 includes one or more resources 105 associated with a domain name and hosted by one or more servers. An example website is a collection of webpages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources include HTML pages, word processing documents, portable document format (PDF) documents, images, video, and news feed sources, to name only a few. The resources can include content, such as words, phrases, images, video and sounds, that may include embedded information (such as meta-information hyperlinks) and/or embedded instructions (such as JavaScript™ scripts).

A user device 106 is an electronic device that is under control of a user and is capable of requesting and receiving resources over the network 102. Example user devices 106 include personal computers (PCs), televisions with one or more processors embedded therein or coupled thereto, set-top boxes, gaming consoles, mobile communication devices (e.g., smartphones), tablet computers and other devices that can send and receive data over the network 102. A user device 106 typically includes one or more user applications, such as a web browser, to facilitate the sending and receiving of data over the network 102.

A user device 106 can request resources 105 from a website 104. In turn, data representing the resource 105 can be provided to the user device 106 for presentation by the user device 106. The data representing the resource 105 can also include data specifying a portion of the resource or a portion of a user display, such as a presentation location of a pop-up window or a slot of a third-party content site or webpage, in which content can be presented. These specified portions of the resource or user display are referred to as slots (e.g., ad slots).

To facilitate searching of these resources, the environment 100 can include a search system 112 that identifies the resources by crawling and indexing the resources provided by the content publishers on the websites 104. Data about the resources can be indexed based on the resource to which the data corresponds. The indexed and, optionally, cached copies of the resources can be stored in an indexed cache 114.

User devices 106 can submit search queries 116 to the search system 112 over the network 102. In response, the search system 112 can, for example, access the indexed cache 114 to identify resources that are relevant to the search query 116. The search system 112 identifies the resources in the form of search results 118 and returns the search results 118 to the user devices 106 in search results pages. A search result 118 can be data generated by the search system 112 that identifies a resource that is provided in response to a particular search query, and includes a link to the resource. Search results pages can also include one or more slots in which other content items (e.g., advertisements) can be presented.

When a resource 105, search results 118 and/or other content (e.g., a video) are requested by a user device 106, the content management system 110 receives a request for content. The request for content can include characteristics of the slots that are defined for the requested resource or search results page, and can be provided to the content management system 110.

For example, a reference (e.g., URL) to the resource for which the slot is defined, a size of the slot, and/or media types that are available for presentation in the slot can be provided to the content management system 110 in association with a given request. Similarly, keywords associated with a requested resource (“resource keywords”) or a search query 116 for which search results are requested can also be provided to the content management system 110 to facilitate identification of content that is relevant to the resource or search query 116.

Based at least in part on data included in the request, the content management system 110 can select content that is eligible to be provided in response to the request (“eligible content items”). For example, eligible content items can include eligible ads having characteristics matching the characteristics of ad slots and that are identified as relevant to specified resource keywords or search queries 116. In addition, when no search is performed or no keywords are available (e.g., because the user is not browsing a webpage), other information, such as information obtained from one or more snapshots, can be used to respond to the received request. In some implementations, the selection of the eligible content items can further depend on user signals, such as demographic signals, behavioral signals or other signals derived from a user profile.

The content management system 110 can select from the eligible content items that are to be provided for presentation in slots of a resource or search results page based at least in part on results of an auction (or by some other selection process). For example, for the eligible content items, the content management system 110 can receive offers from content sponsors 108 and allocate the slots, based at least in part on the received offers (e.g., based on the highest bidders at the conclusion of the auction or based on other criteria, such as those related to satisfying open reservations and a value of learning). The offers represent the amounts that the content sponsors are willing to pay for presentation of (or selection of or other interaction with) their content with a resource or search results page. For example, an offer can specify an amount that a content sponsor is willing to pay for each 1000 impressions (i.e., presentations) of the content item, referred to as a CPM bid. Alternatively, the offer can specify an amount that the content sponsor is willing to pay (e.g., a cost per engagement) for a selection (i.e., a click-through) of the content item or a conversion following selection of the content item. For example, the selected content item can be determined based on the offers alone, or based on the offers of each content sponsor being multiplied by one or more factors, such as quality scores derived from content performance, landing page scores, a value of learning, and/or other factors.

A conversion can be said to occur when a user performs a particular transaction or action related to a content item provided with a resource or search results page. What constitutes a conversion may vary from case-to-case and can be determined in a variety of ways. For example, a conversion may occur when a user clicks on a content item (e.g., an ad), is referred to a webpage, and consummates a purchase there before leaving that webpage. A conversion can also be defined by a content provider to be any measurable or observable user action, such as downloading a white paper, navigating to at least a given depth of a website, viewing at least a certain number of webpages, spending at least a predetermined amount of time on a web site or webpage, registering on a website, experiencing media, or performing a social action regarding a content item (e.g., an ad), such as endorsing, republishing or sharing the content item. Other actions that constitute a conversion can also be used.

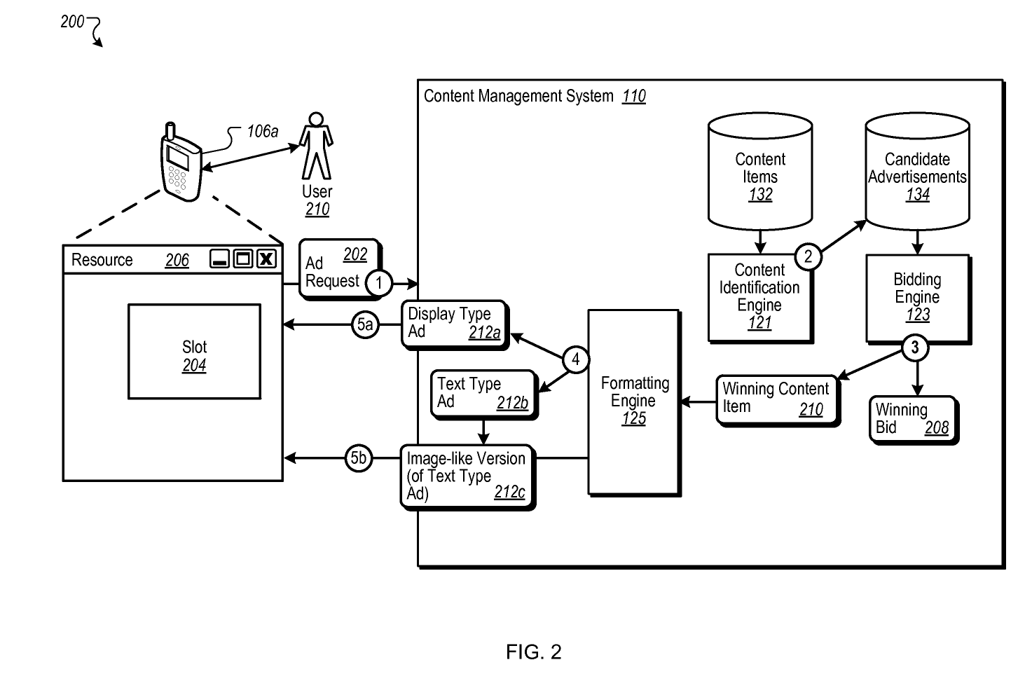

FIG. 2 shows an example system 200 for providing an image-like version of a text ad. For example, in response to an ad request 202, the content management system 110 can identify a winning content item 210, e.g., that is associated with a winning bid among other bids associated with other candidate advertisements 134. If the winning content item 210 is a display type ad 212a, for example, then the display type ad 212a can be provided (e.g., as is) in response to the ad request 202. Otherwise, if the winning content item 210 is a text type ad 212b, then an image-like version 212c can be created from the text type ad 212b, and the image-like version 212c can be provided in response to the ad request 202. In some implementations, the image-like version 212c can be generated, for example, by adjusting or adding rendering parameters associated with the text ad, so as to enable display of the image-like version 212c, which can be provided with the adjusted rendering parameters for display responsive to the received request.

At stage 1, for example, the content management system 110 can receive a request for content (e.g., the ad request 202). The ad request 202, for example, can be received from a user device 106a for presentation of an ad in a slot 204 (e.g., an ad slot) associated with the resource 206. The ad request 202 can include one or more selection criteria (e.g., slot size, keywords, etc.), including at least one selection criterion that indicates a preference for display advertisements. For example, the resource 206 can be a web page for which the associated publisher has designated that display ads are to appear in the slot 204 (or generally, any slots on the publisher's page).

At stage 2, for example, the content identification engine 121 can identify candidate content items (e.g., candidate advertisements 134) from the inventory of content items 132 using the one or more selection criteria without regard for the preference (for display advertisements). For example, the candidate content items can be identified, at least in part, by matching keywords or other information in the ad request 202, as described above with reference to FIG. 1. The inventory of content items 132 (and resulting identified candidate advertisements 134) can include both display ads and other types of ads, including text ads for which associated content sponsors have designated that generation of image-like ads is allowed.

At stage 3, for example, the bidding engine 123 can initiate a selection process. In some implementations, the bidding engine 123 can conduct an auction, including using bids associated with the identified candidate advertisements 134, to determine a winning bid 208 associated with a winning content item 210. The auction can be conducted, for example, without regard to the preference (for display advertisements) that may exist relative to the ad request 202. For example, the winning content item 210 (having the winning bid 208) can be a text type advertisement. In this regard, one or more otherwise ineligible content items that are in inventory (i.e., ineligible because they are not of the correct format (e.g., text rather than display type)) can still be processed as part of the selection process and still be declared winners of a given selection process.

At stage 4, for example, the formatting engine 125 can determine a type of the content item (e.g., advertisement) associated with the winning bid 208 (e.g., associated with the winning content item 210). For example, depending on whether the winning content item 210 is a display type ad 212a or a text type ad 212b, the formatting engine 125 can perform additional processing.

At stage 5a, for example, when the winning bid 208 is associated with a display advertisement, the content management system 110 can directly provide the display type ad 212a responsive to the request, e.g., including providing the display type ad 212a as-is, without making any changes in formatting.

At stage 5b, for example, when the winning bid 208 is associated with a text type ad 212b or other type advertisement, then the formatting engine 125 can adjust or add rendering parameters prior to providing the content item. For example the formatting engine 125 can adjust or add rendering parameters associated with the text type ad 212b. For example, the image-like version 212c can be created, such as to enable display of an image-like version of the text type ad 212b, and the image-like version 212c can be provided with the adjusted rendering parameters for display responsive to the received request.

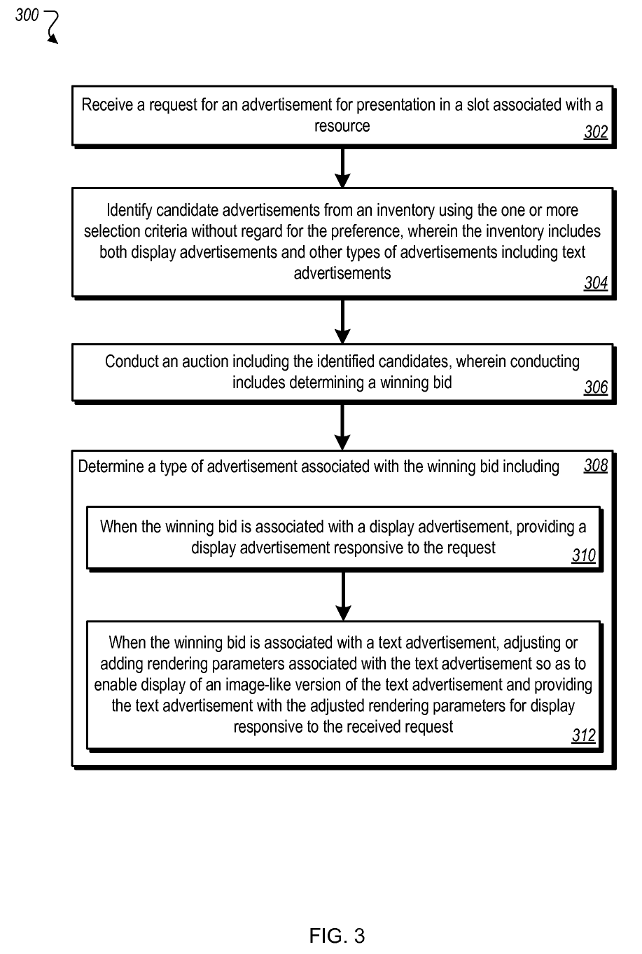

FIG. 3 is a flowchart of an example process 300 for providing an image-like version of the text content item in response to a received request for content. In some implementations, the content management system 110 can perform steps of the process 300 using instructions that are executed by one or more processors. FIGS. 1-2 are used to provide example structures for performing the steps of the process 300. In some implementations, the process 300 can be used to generate and provide image-like versions of other types of content items, i.e. in addition to advertisements for which examples are provided in this document.

A request is received for an advertisement for presentation in a slot associated with a resource (302). The request includes or is associated with one or more selection criteria, wherein at least one selection criterion indicates a preference for display advertisements. As an example, the content management system 110 can receive the ad request 202 from the user device 106a, requesting an ad to fill the slot 204. The ad request 202 can include one or more selection criteria (e.g., slot size, keywords, etc.) including at least one selection criterion that indicates a preference for display advertisements. The resource 206, for example, can be a web page for which the associated publisher has designated that display ads are to appear in the slot 204.

Candidate advertisements are identified from an inventory using the one or more selection criteria without regard for the preference, wherein the inventory includes both display advertisements and other types of advertisements including text advertisements (304). For example, the content identification engine 121 can identify candidate advertisements 134 from the inventory of content items 132 using the one or more selection criteria without regard for the preference (for display advertisements). Accordingly, the content identification engine can identify, as candidate advertisements 134, ads that are of multiple different types, including at least some ads that are display ads and at least some of which are text ads. The candidate advertisements 134 can be identified, at least in part, by matching keywords or other information in the ad request 202. The candidate advertisements 134 that are identified can include display ads (and other non-text ads), and can also include text ads, e.g., for which associated content sponsors have designated that generation of image-like ads is allowed.

An auction is conducted, including the identified candidates, wherein conducting includes determining a winning bid (306). The bidding engine 123, for example, can conduct an auction, including using bids associated with the identified candidate advertisements 134, to determine a winning bid 208 associated with a winning content item 210. For example, the auction can be conducted without regard to the preference (for display advertisements) that may exist relative to the ad request 202. As a result of the auction, for example, the winning content item 210 may be a text type advertisement.

A type of advertisement associated with the winning bid is determined (308). For example, the formatting engine 125 can determine a type of the winning content item 210, e.g., either the display type ad 212a or the text type ad 212b.

When the winning bid is associated with a display advertisement, a display advertisement is provided responsive to the request (310). As an example, when the winning bid 208 is associated with the display type ad 212a, the content management system 110 can provide a display type ad 212a responsive to the request as-is, i.e., without making any changes in formatting.

When the winning bid is associated with a text advertisement, rendering parameters associated with the text advertisement are adjusted or added so as to enable display of an image-like version of the text advertisement and the text advertisement is provided with the adjusted rendering parameters for display responsive to the received request (312). For example, when the winning bid 208 is associated with the text type ad 212b, then the formatting engine 125 can adjust or add rendering parameters associated with the text type ad 212b. The image-like version 212c can be created, for example, such as to enable display of an image-like version of the text type ad 212b. The text type ad 212b can be provided in response to the ad request 202, for example, with the adjusted rendering parameters for display responsive to the received request.

In some implementations, the rendering parameters that are adjusted can relate to a background shading. For example, if the original text ad includes text with a plain background, the rendering parameters that are updated or added can include parameters that provide a color background for the text. Different forms of the background can occur, for example, including a single color, gradients of a single color, multi-color patterns, hash patterns, or other background shading.

In some implementations, the background shading of the rendering parameters is configured to darken on hover in order to make the winning content item more “display like”. As an example, the image-like version 212c of an ad can initially be displayed in one way, such as using a particular color shade (e.g., light blue). Subsequently, if the user employs controls (e.g., touch, mouse, keyboard keys, trackball, stylus or other input) to cause the cursor to be located on ad, the shade of the ad can darken (e.g., to a medium blue). One or more other colors or other visual features can also change. In some implementations, one or more sounds can be used at a time of hovering, e.g., in addition to (or instead of) changes to color and/or other visual aspects.

In some implementations, the rendering parameters that are adjusted or added can include a selection of typeface, wherein adjusting includes selecting a typeface that is different than a typeface originally associated with the text advertisement. For example, for a text ad selected from the content items 132 that has Font A, the formatting engine 125 can change the font to something different, such as a different presentation of Font A, a presentation that uses Font B or another font, or some other text style or typeface change, e.g., bolding, italics, underlining, or other style change(s).

In some implementations, the rendering parameters can include spacing, wherein adjusting includes expanding spacing between elements of the text advertisement including adjusting spacing for one or more of the title, uniform resource locator, or body text. For example, to create the image-like version 212c from the text type ad 212b, the formatting engine 125 can make changes to spacing between words and/or phrases, such as to present the text in a unique way and/or to grab the attention of the user viewing the ad.

In some implementations, the process 300 can further include adding an item (e.g., a control) to the text advertisement, e.g., a control, an arrow, a chevron, or favicon. For example, the formatting engine 125 can add, to the image-like version 212c, a control with which the user can interact. In some implementations, the control can be or include a call-to-action control. For example, the arrow, chevron, favicon or other control that is added to the ad can be associated with an additional user action or interaction point, such as indicated by descriptive text that indicates an action that is to be performed or completed by the user. For example, a control, if selected by the user, can provide more information (e.g., phone number, address, URL, etc.) associated with the ad.

In some implementations, rendering parameters can include a positioning parameter, and adjusting the rendering parameters associated with the text advertisement can include adjusting positioning of elements of the textual advertisement to fill the slot. For example, the formatting engine 125 can include rendering parameters that will cause the text to be presented in a certain way, e.g., with a particular justification. In another example, the rendering parameters can cause the text to be adjusted in one or more particular ways, e.g., to increase the size of the font to fill the ad slot.

In some implementations, the rendering parameters can include a background color, and adjusting the rendering parameters associated with the text advertisement can include setting the background color to a new single color. For example, the formatting engine 125 can include rendering parameters that cause the background of image-like ads to be a particular color, e.g., blue, or some other color that is device-dependent in order to provide an offsetting background color for an ad.

In some implementations, the rendering parameters can include a spacing parameter, and wherein adjusting includes tightening spacing, as compared to an original spacing, in a title of the text advertisement. As an example, the formatting engine 125 can include rendering parameters that cause special spacing to occur in titles, e.g., to increase or decrease letter spacing in title, or to change margins, in order to provide a visually interesting title.

In some implementations, instead of (or in addition to) real-time creation of image-like ads from text ads, the generation of image ads from text ads can occur ahead of time (e.g., prior to received requests for ads to fill ad slots), and the images ads can be stored as available inventory. In some implementations, image ads that are generated in real-time, as described above, can be stored for re-use in response to subsequent requests for the same ads.

In some implementations, different formats of image-like versions 212c can be used (e.g., selected at random), and machine learning or other techniques can be used over time to determine which formats and/or presentations of image-like versions 212c are most successful. For example, user interactions, including click-throughs and conversions, can be tracked (e.g., anonymously), and formats that have the best performance can be retained, and low-performance formats/presentations can be used less or can be discontinued.

In some implementations, content sponsors (e.g., advertisers) can be presented with interfaces (or have included in existing content sponsor interfaces) one or more interfaces for agreeing to allow the content sponsors content item (e.g., advertisement) to be converted from a text for mat to the more image-like format. For example, when the content sponsor is configuring a campaign, an option can be presented (e.g., for a creative) to provide content sponsor agreement to produce image-like content items from text content items. In some implementations, content sponsors can be provided with controls to select specific formats of the image-like content items that will be produced. For example, content sponsors can select the formats of the content items and specify the appearance of functionality of call-to-action controls, if any, that are to be presented. Other content sponsor interfaces are possible.

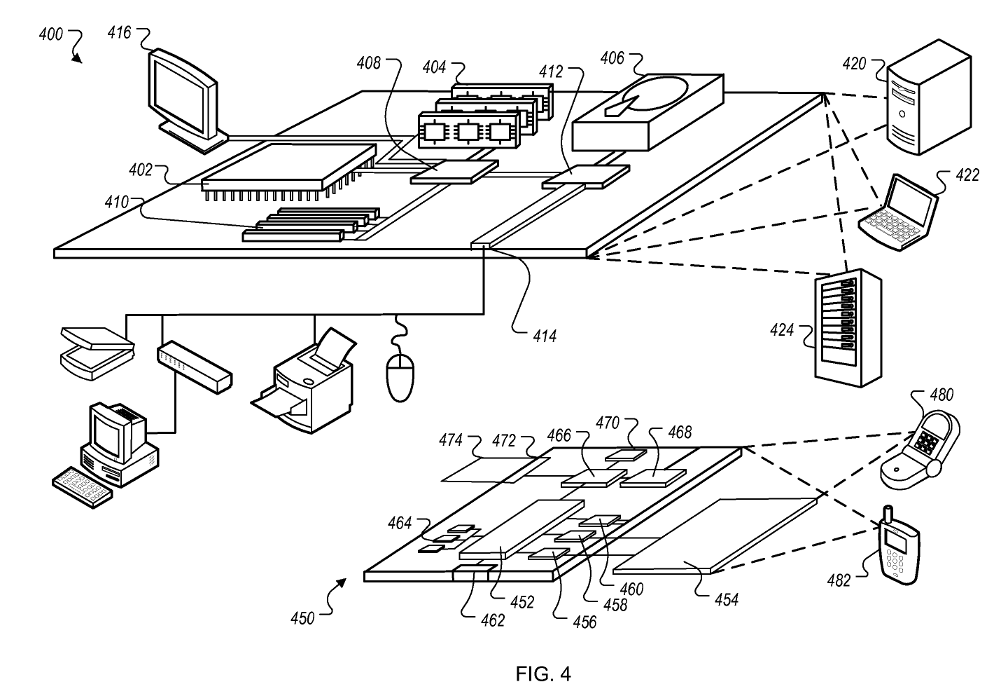

FIG. 4 is a block diagram of example computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 400 is further intended to represent any other typically non-mobile devices, such as televisions or other electronic devices with one or more processers embedded therein or attached thereto. Computing device 450 is intended to represent various forms of mobile devices, such as personal digital assistants, cellular telephones, smartphones, and other computing devices. The components shown here, their connections and relationships, and their functions, are meant to be examples only, and are not meant to limit implementations of the inventions described and/or claimed in this document.

Computing device 400 includes a processor 402, memory 404, a storage device 406, a high-speed controller 408 connecting to memory 404 and high-speed expansion ports 410, and a low-speed controller 412 connecting to low-speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high-speed controller 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high-speed controller 408 manages bandwidth-intensive operations for the computing device 400, while the low-speed controller 412 manages lower bandwidth-intensive operations. Such allocation of duties is an example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed bus 414. The low-speed bus 414 (e.g., a low-speed expansion port), which may include various communication ports (e.g., USB, Bluetooth®, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing devices 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a micro-drive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provided in communication with processor 452, so as to enable near area communication of computing device 450 with other devices. External interface 462 may provide, for example, for wired communication (e.g., via a docking procedure) or for wireless communication (e.g., via Bluetooth® or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to computing device 450 through expansion interface 472, which may include, for example, a subscriber identification module (SIM) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIM cards, along with additional information, such as placing identifying information on the SIM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through transceiver 468 (e.g., a radio-frequency transceiver). In addition, short-range communication may occur, such as using a Bluetooth®, WiFi, or other such transceiver (not shown). In addition, GPS receiver module 470 may provide additional wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smartphone 482, personal digital assistant, or other mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. Other programming paradigms can be used, e.g., functional programming, logical programming, or other programming. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method of content format conversion, comprising:
receiving, by a content management system having one or more processors, from a client device, a request for content for presentation in a slot of an information resource, the request including a selection criterion specifying insertion of a first format of content in the slot, the first format including one of a text format or an image format;
identifying, by the content management system, candidate content items from a database based on the one or more selection criteria, the database including a first content item of the first format and a second content item of a second format, the second format including one of the text format or the image format, the second format different from the first format;
performing, by the content management system, a content selection process with the candidate content items including the first content item of the first format and the second content item of the second format;
selecting, by the content management system, from the candidate content items including the first content item of the first format and the second content item of the second format, the second content item of the second format based on the content selection process;
modifying, by the content management system, first rendering parameters of the second content item of the second format to generate second rendering parameters of the second content item, the second rendering parameters corresponding to the first format; and
providing, by the content management system, to the client device, the second content item with the second rendering parameters for display in the slot of the information resource specifying the insertion of the first format of content, responsive to the request for content for presentation in the slot.

2. The method of claim 1, wherein the second rendering parameters include a background shading.

3. The method of claim 2, wherein the background shading of the second content item is configured to darken on hover.

4. The method of claim 1, wherein the second rendering parameters include a selection of typeface and wherein modifying includes selecting a first typeface different from a second typeface originally associated with the second content item.

5. The method of claim 1, wherein the second rendering parameters include spacing, and wherein modifying includes expanding the spacing between elements of the second content item including adjusting spacing for one or more of a title, a uniform resource locator, or body text.

6. The method of claim 1, further comprising adding an item to the second content item, the item selected from the group comprising a control, an arrow, a chevron, and favicon.

7. The method of claim 6, wherein the control includes a call-to-action control.

8. The method of claim 1, wherein the second rendering parameters include a positioning parameter, and wherein modifying includes adjusting positioning of elements of the second content item to fill the slot.

9. The method of claim 1, wherein the second rendering parameters include a background color, and wherein modifying includes setting the background color to a new single color.

10. The method of claim 1, wherein the second rendering parameters include a spacing parameter, and wherein modifying includes tightening the spacing, as compared to an original spacing, in a title of the second content item.

11. A computer program product embodied in a non-transitory computer-readable medium including instructions, that when executed, cause one or more processors to:
receive, from a client device, a request for content for presentation in a slot of an information resource, the request including a selection criterion specifying insertion of a first format of content in the slot, the first format including one of a text format or an image format;
identify candidate content items from a database based on the one or more selection criteria, the database including a first content item of the first format and a second content item of a second format, the second format including one of the text format or the image format, the second format different from the first format;
perform a content selection process with the candidate content items including the first content item of the first format and the second content item of the second format;
select, from the candidate content items including the first content item of the first format and the second content item of the second format, the second content item of the second format based on the content selection process;
modify first rendering parameters of the second content item of the second format to generate second rendering parameters of the second content item, the second rendering parameters corresponding to the first format; and
provide, to the client device, the second content item with the second rendering parameters for display in the slot of the information resource specifying the insertion of the first format of content responsive to the request for content for presentation in the slot.

12. The computer program product of claim 11, wherein the second rendering parameters include a background shading.

13. The computer program product of claim 11, wherein the background shading of the second content item is configured to darken on hover.

14. The computer program product of claim 11, wherein the second rendering parameters include a selection of typeface and wherein modifying includes selecting a first typeface different from a second typeface originally associated with the second content item.

15. The computer program product of claim 11, wherein the second rendering parameters include spacing, and wherein modifying includes expanding the spacing between elements of the second content item including adjusting the spacing for one or more of a title, uniform resource locator, or body text.

16. A system to convert formatting of content, comprising:
one or more processors; and
one or more memory elements including instructions that, when executed, cause the one or more processors to:
receive, from a client device, a request for content for presentation in a slot of an information resource, the request including a selection criterion specifying insertion of a first format of content in the slot, the first format including one of a text format or an image format;
identify candidate content items from a database based on the one or more selection criteria, the database including a first content item of the first format and a second content item of a second format, the second format including one of the text format or the image format, the second format different from the first format;
perform a content selection process for the candidate content items including the first content item of the first format and the second content item of the second format;
select, from the candidate content items including the first content item of the first format and the second content item of the second format, the second content item of the second format based on the content selection process;
modify first rendering parameters of the second content item to generate second rendering parameters of the second content item, the second rendering parameters corresponding to the first format; and
provide, to the client device, the second content item with the second rendering parameters for display in the slot of the information resource specifying the insertion of the first format of content responsive to the request for content for presentation in the slot.

17. The system of claim 16, wherein the second rendering parameters include a background shading.

18. The system of claim 16, wherein the background shading of the second content item is configured to darken on hover.

19. The system of claim 16, wherein the second rendering parameters include a selection of typeface and wherein adjusting includes selecting a first typeface different from a second typeface originally associated with the second content item.

20. The system of claim 16, wherein the second rendering parameters include spacing, and wherein modifying includes expanding the spacing between elements of the second content item including adjusting the spacing for one or more of a title, uniform resource locator, or body text.
